(19) United States
(12) Patent Application Publication
(10) Pub. No.: US 2004/0192827 A1
(43) Pub. Date: Sep. 30, 2004

(54) Method of pretreating automotive paint powder for use in sealants and composition produced therefrom

(76) Inventors: Siddhartha Asthana, Ann Arbor, MI (US); Michelle Sangsland, Jackson, MI (US)

Correspondence Address: Killworth, Gottman, Hagan & Schaeff, L.L.P., Suite 500, One Dayton Centre, One South Main Street, Dayton, OH, 45402-2023, US

(21) Appl. No.: 10/401,828

(22) Filed: Mar. 28, 2003

(51) Int. Cl. C08K 3/00

(52) U.S. Cl. 524/500

(57) ABSTRACT

A method of pretreating dried automotive paint powder for use in a sealant or adhesive composition is provided. The method includes heating the automotive paint powder to a temperature between about 150° F. to 400° F. (about 65° C. to 204° C.) to reduce volatile compounds in the powder. The paint powder may then be added to a sealant or adhesive composition which is heated during its manufacture and use without the release of hazardous gases into the manufacturing environment.

### BACKGROUND OF THE INVENTION

The present invention is directed to a method of pretreating automotive paint powder prior to its use in the manufacture of adhesives or sealants, and more particularly, to a method of pretreating automotive paint powder which results in the reduction of volatile compounds in the powder and allows it to be processed into sealant or adhesive compositions.

The paint and coatings industry is a major source of chemical wastes. Paint waste including paint sludge or paint powders are produced in the appliance industry, metal fabricating industry, and the automotive industry. Such wastes are generated when paint is sprayed onto a substrate such as an automobile part. The portion of the paint that does not affix to the part becomes waste paint. Current methods for disposing of waste paint include disposing the paint in landfills. However, the cost and the environmental impact of disposing of paint waste in this manner has been a concern in the industry.

In recent years, a number of processes have been developed for converting paint waste into useful products, thereby reducing the amount of disposed waste. For example, U.S. Pat. No. 5,954,970 teaches a method of treating paint sludge and processing it in the form of a dried powder which may be used as a component in asphalt, concrete, and sealants. U.S. Pat. No. 5,922,834 teaches a method for treating waste paint sludge which may be used in compositions such as pressure sensitive sealants automotive sealants, and asphalt cement coatings. Commonly assigned U.S. application Ser. No. 10/218,992, filed Aug. 14, 2002 teaches a vibration damping composition which includes an amount of dried automotive powder as a filler.

### SUMMARY OF THE INVENTION

Prior sealant compositions have used dried powder directly in the form from which it is processed from paint sludge. In this form, the dried powder still contains large amounts of volatile compounds. We have found that in applications where dried automotive powder is used in the manufacture of adhesive or sealant compositions which are heated during processing, the dried powder can partially depolymerize and/or degrade, releasing potentially hazardous and non-hazardous chemicals in the form of gases. These gases may present a potential health hazard to those working in the manufacturing environment during the processing of the compositions as well as during their subsequent use, such as in automotive manufacturing plants. In addition, we have found that such gases may cause undesirable bubbling and the formation of gas pockets in the finished sealant/adhesive products.

Accordingly, there is still a need in the art to be able to use dried paint powder in the manufacture of sealants or adhesives which are exposed to elevated temperatures during manufacturing and use while avoiding the problem of the release of undesirable and potentially hazardous chemicals from the paint powder during processing.

The present invention meets that need by providing a method of pretreating dried automotive paint powder to reduce the volatile compounds contained in the powder prior to its use in the manufacture of adhesive or sealant compositions.

According to one aspect of the present invention, a method of pretreating automotive paint powder to be used as a component in a sealant or adhesive composition is provided. The method includes providing dried automotive paint powder, heating the automotive paint powder to a temperature sufficient to reduce volatile compounds in the paint powder, and adding the paint powder to a sealant or adhesive composition. By “dried” automotive paint powder, it is meant dried polymer resin formed by treating paint waste generated in an automotive paint spray process as described, for example, in U.S. Pat. Nos. 5,573,587, 5,765,293 and 6,099,898, the disclosures of which are incorporated herein by reference.

The paint powder is pretreated by heating to a temperature of between about 150° F. to about 400° F. (about 65° C. to about 204° C.), and more preferably to a temperature of about 250° F. (121° C.). The paint powder is preferably heated for about 2 to 60 minutes, and more preferably, for about 20 to 30 minutes. The paint powder is preferably heated in an inert atmosphere. Upon heating, volatile chemicals are released such that the powder can thereafter be incorporated in an adhesive or sealant composition which is subjected to heat during its manufacture or use without deleterious effects on either the environment or the finished product.

In a preferred embodiment of the invention, the method of pretreating comprises providing dried automotive paint powder, heating the automotive paint powder to a temperature of between about 150° F. to about 400° F. (about 65° C. to about 204° C.) for about 30 minutes to reduce volatile compounds in the paint powder, and adding the paint powder to a sealant or adhesive composition. When the sealant or adhesive composition is heated during its manufacture or use, no undesirable gases are released to the atmosphere or become entrapped in the composition.

The pretreated paint powder is preferably incorporated into an adhesive or sealant composition comprising a synthetic rubber polymer; a thermoplastic polymer, a thermosetting polymer, or a mixture thereof; and dried automotive paint powder; wherein the paint powder has been pretreated by heating to reduce volatile compounds in the paint powder. The adhesive or sealant composition may further include additives such as fillers, adhesion promoters, tackifiers, extenders, processing oils, plasticizers, antioxidants and UV light stabilizers.

Accordingly, it is a feature of the present invention to provide a method of pretreating dried automotive paint powder to reduce volatile compounds in the powder so that it is safe for use in a sealant or adhesive composition which is heated during manufacturing and during use, such as in automotive applications. Other features and advantages of the invention will be apparent from the following description, the accompanying drawing, and the appended claims.

### BRIEF DESCRIPTION OF THE DRAWINGS

FIG. 1 is a graph illustrating the optimum heating time for the paint powder to reduce volatile compounds in accordance with the present invention.

### DETAILED DESCRIPTION OF THE PREFERRED EMBODIMENTS

The method of the present invention provides a way of pretreating dried paint powder so that it may be safely used in processes requiring elevated temperatures, such as in the manufacture of adhesive and/or sealants. By heating the paint powder for specified temperatures and times, volatile compounds can be safely released during pretreatment such that substantially no harmful chemicals or gases are subsequently released into the manufacturing environment during processing of the adhesive or sealant composition and during its subsequent use. In addition, the pretreatment method of the present invention avoids the problem of the formation of undesirable bubbles and/or gas pockets in finished adhesive/sealant products which may occur when using dried paint powder which has not been pretreated.

The dried automotive paint powder used in the present invention is comprised of inert, cured, mixed polymeric thermoplastic resins. Suitable paint powders for use in the present invention include include Dry Pure I or Dry Pure II, commercially available from Haden, Inc.

The pretreatment method of the present invention is preferably carried out by heating the paint powder to a temperature of between about 200 and 300° F. (about 93 to 150° C.) for about 20 to 40 minutes. Another optimal pretreatment range is from about 320° F. to 392° F. (160° C. to 200° C.) for about 15 to 30 minutes. The paint powder is heated in an inert atmosphere, in air, or in a mixture of air and inert gases. Pre-treatment in an inert atmosphere is preferred as it eliminates oxidation products which are produced with the use of air. The paint powder is preferably placed in a device such as an oven or dryer which is maintained at a positive pressure of 1-5 atmospheres using inert gases or air. The dryer may be a continuous dryer where the paint powder is fed in continuously or it can be a batch dryer.

We have found that pretreating at a temperature of about 250° F. (121° C.) for about 30 minutes results in the most efficient release of undesirable degradation products such as volatile organic compounds. These conditions were chosen because they imitate the actual temperatures used during mixing and in automotive low bake cycle processes. The reduction of potentially hazardous compounds has been tested using gas chromatography-mass spectrometry, and it has been found that the concentrations of compounds such as formaldehyde and acrolein contained in the paint powder were reduced by about 99% using the method of the present invention.

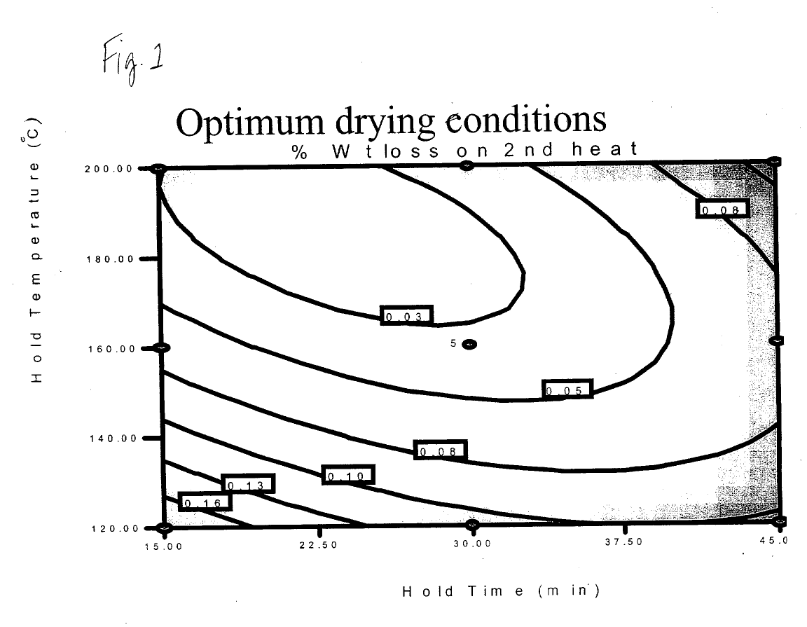

Referring now to FIG. 1, a contour graph is shown which illustrates the weight percentage of gases released when paint powder (which has been pretreated in accordance with the present invention) is subjected to a second heating, such as may occur when the paint powder is mixed with components in a sealant composition. The paint powder was pretreated at temperatures ranging from 248° F. to 392° F. (120° C. to 200° C.) for about 15 to 45 minutes. During pretreatment, the amount of gases released from the powder was about 1 to 5% by weight. The “second heat” took place at a temperature of 120° C. for about 240 minutes. As can be seen from FIG. 1, the amount of gases released during the second heat is minimal.

After pretreatment, the paint powder may be incorporated into a sealant or adhesive composition. Examples of a preferred sealant compositions containing the pretreated paint powder of the present invention include sound and vibration damping compositions and self-adhesive vibration damping compositions. Such compositions preferably comprise, in addition to the pretreated paint powder, a synthetic rubber polymer such as butyl rubber or polyisobutylene, and a thermoplastic or thermosetting polymer such as an amorphous polyolefin or an ethylene-based copolymer or terpolymer. The polymers may comprise homopolymers or copolymers. The composition may comprise from about 5 to 95% by weight of the polymers and from about 5 to 80% of the paint powder. Such compositions may be used to seal gaps between metal parts where sound and vibration deadening is required, such as in automotive applications.

We have found that in applications where the sealant composition is heated during its use, such as in a high heat paint bake oven, degassing of the sealant is substantially reduced.

In order that the invention may be more readily understood, reference is made to the following examples which are intended to illustrate the invention, but not limit the scope thereof.

### EXAMPLE 1

A sample of dried paint film was analyzed by gas chromatography/mass spectrometry to identify any hazardous materials which would volatilize at 350° F. A 2.8 mg portion was held in a gas stream at the required temperature for ten minutes, while the volatiles were collected by cold trapping on the gas chromatography column. Gas chromatography/mass spectrometry was performed using the following parameters:

Column: 30 meter ZB-1 methylsilicone

Temperature: 40° C. to 300° C. at 12° C./minute

A standard was run to permit approximate quantitative evaluation of the peaks. A number of volatile compounds were removed upon heating as shown in Table I. The amount removed is designated by ppm concentration.

TABLE I

| Compound | ppm |
|---|---|
| Ethyl chloride | 0.6 |
| Methanol | 3.1 |
| Trimethylamine | 0.1 |
| n-butanol | 31.8 |
| Methyl methacrylate | 1.8 |
| Trimethyl amine | 0.7 |
| (Dimethylamino)ethanol | 2.9 |
| Xylene | 0.2 |
| Styrene | 0.3 |
| 3-methacrylic acid | 10.4 |
| Trimethylbenzene + isomers | 4.5 |
| Butyl methacrylate | 7.8 |
| 1-(2-methoxypropoxy)-2-propanol | 0.8 |
| metheneamine | 0.2 |
| Unknown dimethyl amines | 2.1 |
| Hexadecane | 0.8 |
| Heptadecane | 1.5 |
| octadecane | 1.4 |
| Methylstyrene dimer | 2.5 |
| Alkyl styrene | 9.6 |
| Dibutylsuberate derivative | 1.0 |
| Methyl stearate | 1.7 |
| Methoxymethyl melamine adduct | 16 |
| Tinuvin 328 | 87.2 |

It should be appreciated that because the above sample was heated in air, the volatiles removed also contain oxidation products.

### EXAMPLE 2

A sample of Drypure II was analyzed during three phases. In the first phase, the paint powder was heated in a dryer using an inert gas (helium) at a temperature of 180° C. for 30 minutes. In phase 2, the paint powder was cooled in air for 30 minutes. In phase 3, the powder was mixed with polymers at 148° C. in air for 30 minutes to simulate the conditions under which the paint powder would be formed into a sealant composition.

The concentrations noted below indicate the amount of volatile compounds which were removed during each phase. Blank spaces indicate no measurable amounts were recorded.

TABLE II

| | Phase 1 | Phase 2 | Phase 3 |
|---|---|---|---|
| Compound | (ppm) | (ppm) | (ppm) |
| Methyl alcohol | 11 | | |
| Acrolein | 10 | | |
| Acetone | 2 | | |
| Dichloromethane | 95 | | |
| Trimethylamine | 10 | | |
| Isobutanol | 13 | | |
| 1-butanol | 178 | | |
| Acetone alcohol | 10 | | |
| Methyl methacrylate | 30 | | |
| Glycidol | 25 | | |
| Propylene glycol | 29 | | |
| 1-pentanol | 9 | | |
| 1-octene | 12 | | |
| Styrene | 11 | | |
| 3-methacrylic acid | 120 | | |
| Neopentyl glycol | 26 | | |
| 2-pentenoic acid | 2 | | |
| Butyl methacrylate | 53 | | |
| Dipropyleneglycol methyl ethers | 9 | | |
| Glycidyl methacrylate | 7 | | |
| TMPD (alcohol) | 26 | | |
| Methenamine | 7 | | |
| Glycol methacrylate | 8 | | |
| TMP (alcohol) | 17 | | |
| 1,4-cyclohexane dimethanol | 16 | | |
| Unknown | 17 | | |
| Alkyl styrenes | 21 | | |
| Dimethyl amines | 38 | | |
| Hexa(methoxymethyl)melamine | 219 | | |
| Tinuvin 328 | 372 | 5 | 138 |

As can be seen, the majority of volatile compounds were removed during the first phase.

### EXAMPLE 3

The following sealant composition was prepared using the pretreated paint powder of the present invention. The amounts are shown as percentages by weight of the total composition. The sound and vibration damping composition is preferably used on automobile floors, doors, roofing, and the like. This composition is described in commonly assigned application Ser. No. 10/218,992 filed Aug. 14, 2002.

Vibration Damping Sealant Composition

| | |
|---|---|
| Butyl rubber¹ | 5.01 |
| Antioxidant² | 0.30 |
| Carbon black | 1.00 |
| Oleic acid | 0.10 |
| Barium sulfate | 40.04 |
| Pretreated paint powder | 25.19 |
| Fumed silica³ | 1.0 |
| Polyisobutylene⁴ | 4.67 |
| Aliphatic hydrocarbon resin⁵ | 5.01 |
| Polybutene⁶ | 17.68 |

¹Exxon 065 from Exxon Chemical
²Wingstay L from Goodyear
³Aerosil 200 from Degussa
⁴LMMH from Exxon Chemical
⁵Nevtac 100 from Neville Chemical
⁶H1900 from Amoco

It will be apparent to those skilled in the art that various changes may be made without departing from the scope of the invention which is not considered limited to what is described in the specification.

What is claimed is:

1. A method of pretreating automotive paint powder to be used as a component in a sealant or adhesive composition comprising:
providing dried automotive paint powder;
heating said automotive paint powder to a temperature sufficient to reduce volatile compounds in said paint powder; and
adding said paint powder to a sealant or adhesive composition.

2. The method of claim 1 including heating said sealant or adhesive composition during the manufacture thereof.

3. The method of claim 1 wherein said paint powder is heated to a temperature of between about 150° F. to about 400° F. (about 65° C. to about 204° C.).

4. The method of claim 1 wherein said paint powder is heated to a temperature of about 250° F. (about 121° C.).

5. The method of claim 1 wherein said paint powder is heated for about 20 to 40 minutes.

6. The method of claim 1 wherein said paint powder is heated for about 30 minutes.

7. The method of claim 1 wherein said paint powder is heated in an inert atmosphere.

8. A method of pretreating automotive paint powder to be used as a component in a sealant or adhesive composition comprising:
providing dried automotive paint powder;
heating said automotive paint powder to a temperature of between about 200° F. to about 300° F. (about 93 to 150° C.) for about 30 minutes to reduce volatile compounds in said paint powder; and
adding said paint powder to a sealant or adhesive composition.

9. A sealant or adhesive composition comprising:
a synthetic rubber polymer;
a thermoplastic polymer, a thermosetting polymer, or mixtures thereof; and
dried automotive paint powder; wherein said paint powder has been pretreated by heating to reduce volatile compounds in said paint powder.
